(19) United States
(12) Patent Application Publication
(10) Pub. No.: US 2007/0018582 A1
(43) Pub. Date: Jan. 25, 2007

(54) DISCHARGE BULB

(75) Inventors: Toshiaki Tsuda, Shizuoka (JP); Hiroyuki Takatsuka, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: KOITO MANUFACTURING CO., LTD., Tokyo (JP)

(21) Appl. No.: 11/458,131

(22) Filed: Jul. 18, 2006

(30) Foreign Application Priority Data
Jul. 19, 2005 (JP) 2005-208265

(51) Int. Cl. H01J 61/30; H01J 17/16

(52) U.S. Cl. 313/636

(57) ABSTRACT

A discharge bulb is equipped with a discharge light emitting chamber tube in which discharge electrodes are provided face to face and a luminescent material is filled at the center of the ceramic tube in longitudinal direction. A metallic pipe is jointed into the pore of a tube end communicating with the discharge light emitting chamber. The rear end of an electrode rod inserted into the pipe with its tip protruding into the discharge light emitting chamber to constitute an electrode is jointed to the protruding tip of the pipe. A constricted part is arranged in the part between the tube center corresponding to the discharge light emitting chamber of the ceramic tube and the tube end. The thickness of the tube wall of the tube end is augmented to enhance the thermal shock resistance of the tube end. The thickness of the tube wall at the constricted part is reduced to suppress heat transmission from the discharge light emitting part to the tube end and to improve the light emission efficiency of the arc tube main unit.

The present application claims foreign priority based on Japanese Patent Application No. P. 2005-208265, filed on Jul. 19, 2005, the contents of which are incorporated herein by reference.

### BACKGROUND OF THE INVENTION

1. Field of the Invention

The present invention relates to a discharge bulb equipped with an arc tube in which discharge electrodes are provided face to face and a luminescent material (such as a metal halide) is filled together with a starting rare gas inside a ceramic tube.

2. Related Art

A discharge bulb equipped with a glass arc tube is a common light source for an automobile headlamp. This type of discharge has a problem that the metal halide filled inside a glass tube accelerates corrosion of the glass tube and devitrification and blacking phenomena prevents proper light distribution and the service life of the tube is not so long.

In recent years, as shown in JP-A-2004-362978 (refer to FIG. 7), a discharge bulb has been proposed equipped with a ceramic arc tube including a discharge light emitting chamber s in which discharge electrodes (electrode rods) 214 are provided face to face and a luminescent material is filled together with a starting rare gas. That is, the ceramic arc tube has a structure where a molybdenum pipe 212 is jointed by metallization to a pore 201 at each end of a ceramic tube 200 and the rear end of an electrode rod 214 inserted into the molybdenum pipe 212 so as to protrude its tip into (the discharge light emitting chamber s of) the ceramic tube 200 is jointed (welded) to the rear end of the molybdenum pipe 212 protruding from the ceramic tube 200 in order to seal both ends of the ceramic tube 200 (pores 201 communicating with the discharge light emitting chamber s). A sign 216 represents a lead wire connected to the molybdenum pipe 212 protruding from the end of the ceramic tube 200. The ceramic tube 200 is stable against a metal halide so that a ceramic arc tube has a longer service life than a glass arc tube.

A ceramic tube 200 constituting a ceramic arc tube has better thermal conductivity (higher heat radiation) than a glass tube constituting a glass arc tube. Thus, more heat generated in a discharge light emitting part at the center of a ceramic tube corresponding to the discharge light emitting chamber s is transmitted to the end of the ceramic tube thus presenting a first problem of reduction of the light emission efficiency (luminous flux value with respect to power consumption) of the arc tube.

The ceramic tube has lower thermal shock resistance than the glass tube. In particular, a second problem is that there is a danger of a crack developing at the end of the tube end to which a molybdenum pipe 212 is jointed by metallization.

When the thickness of the entire ceramic tube is reduced to solve the first problem, the thermal capacity of the ceramic tube drops and the amount of heat transmitted to the end of the ceramic tube is reduced thus increasing the light emission efficiency although the thermal shock resistance, especially prevention of a crack in the tube end, is further reduced. When the thickness of the entire ceramic tube is augmented to solve the second problem, the thermal shock resistance is improved while the thermal capacity of the ceramic tube increases and the amount of heat transmitted from the discharge light emitting part to the end of the ceramic tube increases to further decrease the light emission efficiency. In this way, there is a tradeoff between the first problem and the second problem so that it is difficult to solve both problems at the same time.

The inventor has contemplated that, when an entire ceramic tube is formed into a substantially uniform external shape in longitudinal direction, the thermal capacity of the ceramic tube will be reduced and the tube wall thickness of the ceramic tube end will be augmented to enhance the thermal shock resistance, and the thermal capacity increasing as the tube wall at the tube end becomes thicker will be offset by the thermal capacity of the ceramic tube reduced by forming a constricted part between the discharge light emitting part and the tube end, and the wall thickness of the heat transmission path (tube wall corresponding to the constricted part) from the discharge light emitting part to the tube end will be reduced thus suppressing heat transmission from the discharge light emitting part to the tube end (reducing the heat transmission amount) and suppressing a drop in the temperature inside the discharge light emitting chamber, thereby improving the light emission efficiency of the arc tube. The inventor has prototyped a ceramic arc tube (ceramic tube) of such a shape and verified its effect. The inventor has found that this approach is effective for both the first and second problems, which led to this application.

### SUMMARY OF THE INVENTION

The invention has been accomplished in view of the related art problems and the inventor's findings. An object of the invention is to provide an automobile discharge bulb equipped with a ceramic arc tube improved in terms of both thermal shock resistance and light emission efficiency by providing a constricted part in a predetermined position of a ceramic tube.

In accordance with one or more embodiments of the present invention, as a first aspect of the invention, a discharge bulb is provided with: a ceramic arc tube; a discharge light emitting chamber formed at a substantially center of a longitudinal direction of the ceramic arc tube, wherein a luminescent material and a starting rare gas are filled in the discharge light emitting chamber; a metallic pipe provided in a pore, wherein the pore is formed in an end of the ceramic arc tube and communicates with the discharge light emitting chamber; an electrode rod inserted into the metallic pipe, wherein a tip of the electrode rod protrudes into the discharge light emitting chamber to form a discharge electrode and a rear end of the electrode rod is jointed to a protruding tip of the metallic pipe; and a constricted part arranged on the ceramic arc tube between a tube center area corresponding to the discharge light emitting chamber and the tube end area where the pore is made.

(Working effect) The discharge light emitting chamber at an approximately central part in the longitudinal direction of the ceramic tube communicates with a pore arranged in the ceramic tube end area. For example, by forming the external shape of the ceramic tube (external shape of a section orthogonal to the longitudinal direction of the ceramic tube) approximately uniformly in the longitudinal direction, the tube wall in the ceramic tube end area (tube wall surrounding the pore) is made thicker thus enhancing the thermal shock resistance of the ceramic tube end area.

The increase in the thermal capacity of the ceramic tube resulting from a thicker tube wall in the ceramic tube end area is offset by the decrease in the thermal capacity of the ceramic tube resulting from introduction of a constricted part between the ceramic tube central area (discharge light emitting part) and the tube end area.

The constricted part decreases the thickness of the hear transmission path from the ceramic tube central area (discharge light emitting part) to the tube end area. This suppresses hear transmission from the ceramic tube central area (discharge light emitting part) to the tube end area, or in order words, maintains the temperature in the discharge light emitting chamber, to improve the light emission efficiency (luminous flux value with respect to power consumption) of the arc tube.

Further, in accordance with one or more embodiments of the present invention, as a second aspect of the invention, the constricted part may be arranged at a position corresponding to a part between an insert tip of the metallic pipe and the discharge light emitting chamber.

(Working effect) The insert tip of the metallic pipe is placed at a position apart from the discharge light emitting chamber. Thus, heat from the discharge light emitting chamber is more difficult to be transmitted to the metallic pipe so that the thermal stress generated in the ceramic tube end area is smaller than in the related art where a metallic pipe is jointed to substantially the entire area of a pore (the insert tip of the metallic pipe is in close proximity to the discharge light emitting chamber). The ceramic tube end area is less vulnerable to cracks.

In particular, the insert tip of the metallic pipe does not extend to a position corresponding to the constricted part. The heat transmission suppressing effect of the reduced tube wall thickness remains active without being hindered by a metallic pipe with good thermal conductivity.

Further, in accordance with one or more embodiments of the present invention, as a third aspect of the invention, a side of the constricted part facing the discharge light emitting chamber may have a shape of a curved surface that returns light to the discharge light emitting chamber.

(Working effect) Part of the outgoing light from the side of the constricted part facing the discharge light emitting chamber is reflected on the surface of the ceramic tube in the shape of a curved surface. This increases the amount of light emission in the central area of the ceramic tube (discharge light emitting part).

Further, in accordance with one or more embodiments of the present invention, as a fourth aspect of the invention, a reflector to reflect outgoing light toward the inside of the ceramic tube may be arranged in a ceramic tube end area including the constricted part.

(Working effect) Part of the out going light from the ceramic tube area including the constricted part is reflected on the reflector and returns to the inside of the ceramic tube. This increases the amount of light emission in the central area of the ceramic tube (discharge light emitting part).

Further, in accordance with one or more embodiments of the present invention, as a fifth aspect of the invention, the reflector may be composed of a metal-mixed conductive coating.

(Working effect) The conductive coating provided in the ceramic tube end area works as an auxiliary electrode thus enhancing the starting characteristic of an arc tube.

According to the discharge bulb of the first aspect, the tube wall of the ceramic tube end area (tube wall surrounding the pore) is made thicker thus ensuring the thermal shock resistance of the ceramic tube end area and the reduced thickness of the area of the tube wall corresponding to the constricted part suppresses heat transmission from the ceramic tube central area (discharge light emitting part) to the tube end area. This offers a discharge bulb equipped with a ceramic arc tube excellent in both thermal shock resistance and light emission efficiency.

According to the second aspect the thermal shock resistance of the ceramic tube end area is ensured and heat transmission from the ceramic tube central area (discharge light emitting part) to the tube end area is further suppressed. This offers a discharge bulb equipped with a ceramic arc tube excellent in both thermal shock resistance and light emission efficiency.

According to the third aspect, the light emission amount in the ceramic tube central area (discharge light emitting part) increases thus enhancing the light emission efficiency of the ceramic arc tube.

According to the fourth aspect, the light emission amount further increases. With this, the light emission efficiency of the ceramic arc tube is further enhanced.

According to the fifth aspect, the conductive coating provided in the ceramic tube end area works as an auxiliary electrode, which decreases the starting voltage of the discharge bulb.

Other aspects and advantages of the invention will be apparent from the following description and the appended claims.

### BRIEF DESCRIPTION OF THE DRAWINGS

FIG. 1 is a front view of an automobile headlamp that uses as a light source a discharge bulb of a first exemplary embodiment of the invention.

FIG. 2 shows a longitudinal cross-section in vertical direction of the headlamp taken along the line II-II in FIG. 1.

FIG. 3 shows an enlarged longitudinal cross-section in vertical direction of an arc tube as a key part of the discharge bulb.

FIG. 4 shows a transverse cross-section in vertical direction of the arc tube taken along the line IV-IV in FIG. 3.

FIG. 5 shows an enlarged longitudinal cross-section in vertical direction of the arc tube main unit.

FIG. 6 shows a longitudinal cross-section in vertical direction of an arc tube main unit as a key part of a discharge bulb of a second exemplary embodiment of the invention.

FIG. 7 shows a longitudinal cross-section in vertical direction of an arc tube main unit as a key part of the related art discharge bulb.

### DETAILED DESCRIPTION OF THE EXEMPLARY EMBODIMENTS

Exemplary embodiments of the invention will be described with reference to the accompanying drawings.

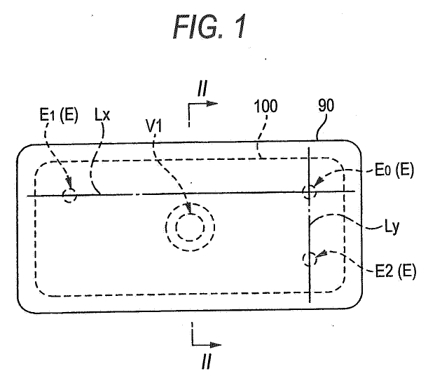

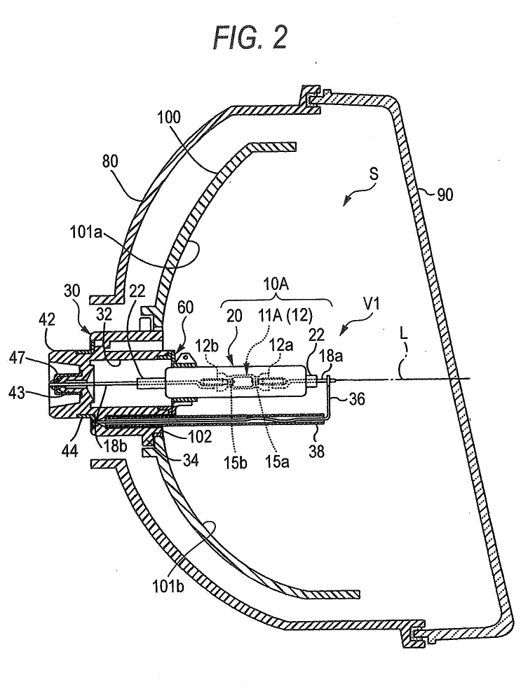

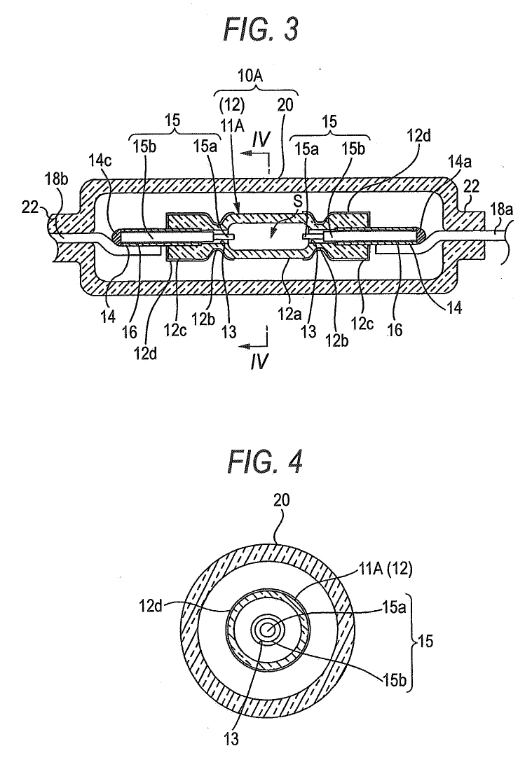

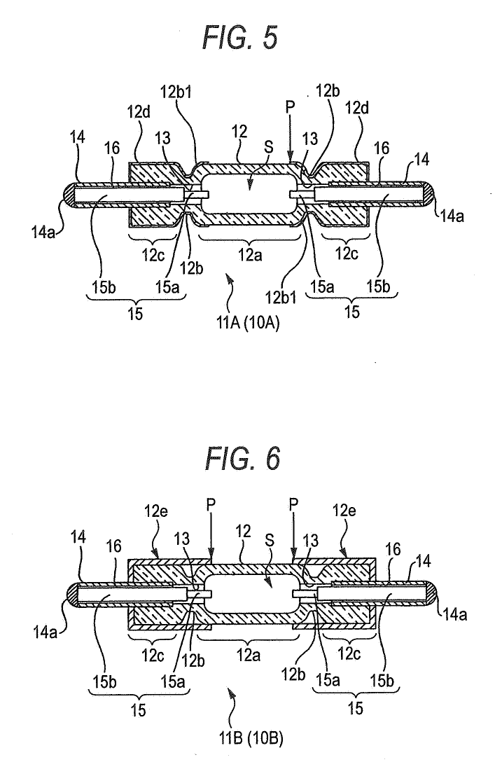

FIGS. 1 through 5 show the first exemplary embodiment of the invention. FIG. 1 is a front view of an automobile headlamp that uses as a light source the discharge bulb of the first exemplary embodiment. FIG. 2 shows a longitudinal cross-section in vertical direction of the headlamp taken along the line II-II in FIG. 1. FIG. 3 shows an enlarged longitudinal cross-section in vertical direction of an arc tube as a key part of the discharge bulb. FIG. 4 shows a transverse cross-section of the arc tube taken along the line IV-IV in FIG. 3. FIG. 5 shows an enlarged longitudinal cross-section in vertical direction of the arc tube main unit.

In these figures, a sign 80 represents the container-shaped lamp body of the automobile headlamp whose front side opens. To the front opening of the lamp body is assembled a transparent front cover to partition a lamp chamber S. In the lamp chamber S is housed a reflector 100 with a discharge bulb V1 inserted into a bulb insert hole 102 at the rear apex. Inside the reflector 100 are formed effective reflecting surfaces 101a, 101b that are aluminum-evaporated. The effective reflective faces 101a, 101b are composed of multiple light distribution steps (multiple reflecting surfaces) having different curved surface shapes. Light emitted from the bulb V1 is reflected on (the effective reflecting surfaces of) the reflector 100 and irradiated forward to form a predetermined light distribution pattern of the headlamp.

As shown in FIG. 1, between the reflector 100 and the lamp body 80 is are interposed an aiming fulcrum E0 of a single ball-joint structure and an aiming mechanism E composed of two aiming screws E1, E2 so as to tilt the optical axis L of the reflector 100 (headlamp) about a horizontal tilting axis Lx and vertical tilting axis Ly, that is, make aiming adjustment of the optical axis L of the headlamp.

A sign 30 represents an insulating base composed of a PPS resin on the periphery of which is arranged a focus ring 34 engaged with the bulb insert hole 102 of the reflector 100. In the forward direction of the insulating base 30 is fixed and supported an arc tube 10A by a metallic lead support 36 as an energizing path extending forward from the base 30 and a metallic support member 60 fixed to the front surface of the base 30 to constitute a discharge bulb V1.

That is, a read wire 18a guided from the front end of the arc tube 10A is fixed by spot welding to the bent tip of the lead support 36 extending from the insulating base 30 so that the front end of the arc tube 10A is supported by the bent tip of the lead support 36. On the other hand, a read wire 18b guided from the rear end of the arc tube 10A is connected to a terminal 47 arranged at the rear end of the base 30 and the rear end of the arc tube 10A is grasped by a metallic support member 60 fixed to the front surface of the insulating base 30.

At the front end of the insulating base 30 is arranged a recess 32, in which the rear end of the arc tube 10A is housed and retained. At the rear end of the insulating base 30 is formed a cylindrical boss 43 enclosed by a cylindrical outer casing 42 extending rearward. On the outer periphery of the root part of the outer casing 42 is integrally fixed a cylindrical belt terminal 44 connected to the lead support 36. To the boss 43 is integrally stuck a cap terminal 47 to which the rear lead wire 18b is connected.

As shown in FIG. 3, the arc tube 10A is composed of an arc tube main unit 11A including a discharge light emitting chamber s in which rod-shaped electrodes 15, 15 are provided face to face and a luminescent material such as a metal halide is filled together with a starting rare gas and cylinder-shaped shroud glass 20 for shielding ultraviolet rays covering the arc tube main unit 11A integrated with the arc tube main unit 11A. From the front/rear end of the arc tube main unit 11A are guided lead wires 18a, 18b electrically connected to the rod-shaped electrodes 15, 15 protruding into the discharge light emitting chamber s. The shroud glass 20 for shielding ultraviolet rays is sealed to the lead wires 18a, 18b to integrate the arc tube main unit 11A and the shroud glass 20. A sign 22 represents a sealed part of the shroud glass 20 of which the diameter is contracted.

The arc tube main unit 11A includes a translucent ceramic tube 12 having a shape of a true Cylinder whose external shape is uniform in longitudinal direction. At the center of the ceramic tube 12 in longitudinal direction is formed a discharge light emitting part 12a to partition a discharge light emitting chamber s. At each end of the ceramic tube 12 is formed a tube end area 12c including a pore 13 communicating with the discharge light emitting chamber s of the discharge light emitting part 12a.

Near the opening at the end of the pore 13 in the tube end area is fixed a molybdenum pipe by metallization jointing. From the end of the ceramic tube 12 protrudes the molybdenum pipe 14. The rod-shaped electrode 15 inserted into the molybdenum pipe and whose tip protrudes into the discharge light emitting chamber s has its rear end welded (jointed) to the protruding tip of the molybdenum pipe 14 so as to be integral with the ceramic tube 12. A pore 13 communicating with the discharge light emitting chambers in which a luminescent material such as a metal halide is filled together with a starting rare gas is sealed. A sign 14a represents a laser welded part.

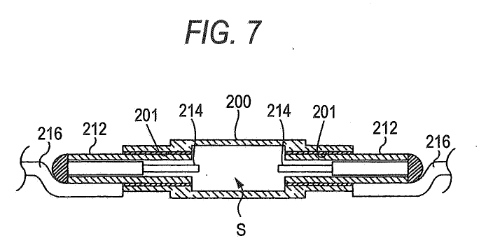

The ceramic tube 12 has the outer shape of its cross section orthogonal to the longitudinal direction formed uniformly in longitudinal direction. The thickness of the tube wall surrounding the pore 13 of the ceramic tube end area 12c is large thus in particular enhancing the thermal shock resistance of the ceramic tube end area 12c compared with the related art ceramic tube (refer to FIG. 7) where the entire tube wall is formed in nearly a uniform thickness.

The molybdenum pipe 14 is jointed to a position near the opening end of the pore 13. The insert tip of the molybdenum pipe 14 is placed at a position apart from the discharge light emitting chambers. Thus, heat from the discharge light emitting chamber s is more difficult to be transmitted to the molybdenum pipe 14 so that the thermal stress generated in the ceramic tube end area 12c is smaller than in the related art (refer to FIG. 7) where a molybdenum pipe is jointed to substantially the entire area of the pore 13 (the insert tip of the molybdenum pipe is in close proximity to the discharge light emitting chamber). The ceramic tube end area 12c is less vulnerable to cracks.

Between the discharge light emitting part 12a as a central area of the ceramic tube and the tube end area 12c is circumferentially arranged a constricted part 12b for reducing the thickness of a tube wall surrounding the pore 13 and suppressing heat transmission from the discharge light emitting part 12a to the tube end area 12c thus enhancing the thermal shock resistance in the tube end area 12c as well as increasing the light emission efficiency in the discharge light emitting part 12a.

In other words, the thickness of the tube wall corresponding to the constricted part is smaller than that of the tube end area 12c. The thickness of the heat transmission path from the ceramic tube central area (discharge light emitting part) 12a to the tube end area 12c is reduced to suppress heat transmission from the ceramic tube central area (discharge light emitting part) 12a to the tube end area 12c. The amount of heat transmission to the tube end area 12c is reduced so that the tube end area 12c is not heated to a higher temperature and the thermal stress generated in the ceramic tube end area is small and the thermal shock resistance is high.

Heat transmission from the ceramic tube central area (discharge light emitting part) 12a to the tube end area 12c is suppressed so that the temperature in the discharge light emitting chamber s is maintained thus improving the light emission efficiency (luminous flux value with respect to power consumption) of the arc tube main unit 11A (discharge light emitting part 12a).

In particular, the constricted part 12b is arranged in the part between the insert tip of the molybdenum pipe 14 and the discharge light emitting chamber s (the insert tip of the molybdenum pipe 14 does not extend to the position corresponding to the constricted part 12b). The heat transmission suppressing effect of the reduced tube wall thickness remains active without being hindered by the molybdenum pipe 14 with good thermal conductivity.

The thickness of the ceramic tube end area 12c is augmented so that the volume (weight) of the ceramic tube 12 increases, which correspondingly adds to the thermal capacity of the ceramic tube 12. That is, the increase and decrease in the thermal capacity of the ceramic tube 12 offset each other. The thermal capacity of the ceramic tube 12 does not show a considerable change when compared with the related art ceramic tube (refer to FIG. 7).

The thickness of the tube wall between the discharge light emitting part 12a and the tube end area 12c (tube wall surrounding the pore 13) is reduced by the constricted part 12b. This reduces the cross sectional area of the heat transmission path from the discharge light emitting part 12a to the tube end area 12c. As a result, a drop in the temperature in the discharge light emitting chamber s is suppressed and the light emission efficiency (luminous flux value with respect to power consumption) of the arc tube main unit 11A (discharge light emitting part 12a) is improved.

As shown in FIG. 5, the side of the constricted part 12b facing the discharge light emitting chamber s is formed into a retroreflective curve (curve having a predetermined curvature) that returns light to the discharge light emitting chamber s. Part of light outgoing from the side 12b1 of the constricted part 12b facing the discharge light emitting chamber s is reflected on the retroreflective curve and returns to the discharge light emitting chamber s so that the light emission amount in the discharge light emitting part 12a increases and the light emission efficiency of the arc tube main unit 11A is further enhanced.

On the outer peripheral surface of the tube end area 12c including the constricted part 12b of the ceramic tube 12 is applied a conductive light shielding film 12d made of a mixture of alumina and tungsten to increase the light emission amount in the discharge light emitting part 12a as well as suppresses generation of glare light. That is, the conductive light shielding film 12d has a white rear surface and a black front surface. Light outgoing from the constricted part 12b and the tube end area 12c is reflected on the conductive light shielding film 12d and reliably returns into the ceramic tube 12, which increases the light emission amount in the discharge light emitting part 12a.

The conductive light shielding film 12d is accurately formed so that the side edge on the central part in the ceramic tube 12 will sit within the range of ±0.5 mm in the axial direction of the position P corresponding to the tip of the rod-shaped electrode 15 in order to prevent generation of glare light from faint light (diffused light specific to a ceramic tube) in the areas 12b, 12c of the ceramic tube 12 except the discharge light emitting part 12a.

The conductive light shielding film 12d is composed of a ceramic coating made of a mixture of alumina and tungsten. This allows the conductive light shielding film 12d to work as an auxiliary electrode and enhances the starting characteristic of the arc tube main unit 11A as well as decreases the starting voltage of the discharge bulb 10A.

The outer diameter of the ceramic tube 12 shown in this embodiment is set to 1.5 to 3.5 mm, preferably 1.5 to 2.5 mm. The inter-electrode distance is set to 2.0 to 6.0 mm. The charged pressure of a starting rare gas (Xe) filled in the discharge light emitting chamber s is set to 0.6 to 1.6 MPa. This configuration places the hot zone in a desirable predetermined position illuminated by a headlamp and obtains a sharp clear-cut line.

The rod-shaped electrode 15 is a tungsten electrode rod 15a with a small diameter on the tip side coaxially and integrally jointed with a molybdenum rod 15b with a large diameter on therearside. Between the molybdenum pipe 14 and (the molybdenum rod 15b of) the rod-shaped electrode 15 is formed a micro-space 16 of for example about 25 micrometers so as to allow insertion of the rod-shaped electrode 15 and absorb the thermal stress generated at both ends of the ceramic tube 12. To the molybdenum pipe 14 protruding from the ceramic tube 12 are fixed the bent tip parts of the lead wires 18a, 18b and the lead wires 18a, 18b and the rod-shaped electrodes 15, 15 are arranged on the same axis (refer to FIGS. 2, 3).

FIG. 6 shows a longitudinal cross-section in vertical direction of an arc tube main unit as a key part of the discharge bulb of a second exemplary embodiment of the invention.

While the conductive light shielding film 12d is formed on the outer peripheral surface of the tube end area 12c including the constricted part 12b of the ceramic tube 12 to prevent an increase in the light emission amount of the arc tube main unit 11A and generation of glare light according to the arc tube 10A (arc tube main unit 11A) of the first exemplary embodiment, a ceramic light shielding cap 12e made of a mixture of alumina and tungsten is integrally stuck to tube end area 12c including the constricted part 12b of the ceramic tube 12 in place of the conductive light shielding film 12d according to the arc tube 11B (arc tube main unit 11B) of the second exemplary embodiment.

The other parts are substantially the same as those in the first exemplary embodiment. They are given the same signs and corresponding description is omitted.

While each of the arc tubes 10A, 10B has a structure where the ceramic arc tube main units 11A, 11B and the shroud glass 20 enclosing the arc tube main units 11A, 11B are integrated together before the insulating base 30 in the foregoing exemplary embodiments, the arc tube main units 11A, 11B arranged before the insulating base 30 may be the ceramic arc tube main units 11A, 11B without the shroud glass 20.

It will be apparent to those skilled in the art that various modifications and variations can be made to the described exemplary embodiments of the present invention without departing from the spirit or scope of the invention. Thus, it is intended that the present invention cover all modifications and variations of this invention consistent with the scope of the appended claims and their equivalents.

What is claimed is:

1. A discharge bulb comprising:
a ceramic arc tube;
a discharge light emitting chamber formed at a substantially center of a longitudinal direction of the ceramic arc tube, wherein a luminescent material and a starting rare gas are filled in the discharge light emitting chamber;
a metallic pipe provided in a pore, wherein the pore is formed in an end of the ceramic arc tube and communicates with the discharge light emitting chamber;
an electrode rod inserted into the metallic pipe, wherein a tip of the electrode rod protrudes into the discharge light emitting chamber to form a discharge electrode and a rear end of the electrode rod is jointed to a protruding tip of the metallic pipe; and
a constricted part arranged on the ceramic arc tube between a tube center area corresponding to the discharge light emitting chamber and the tube end area where the pore is made.

2. The discharge bulb according to claim 1, wherein the constricted part is arranged at a position corresponding to a part between an insert tip of the metallic pipe and the discharge light emitting chamber.

3. The discharge bulb according to claim 1, wherein a side of the constricted part facing the discharge light emitting chamber has a shape of a curved surface that returns light to the discharge light emitting chamber.

4. The discharge bulb according to claim 1, further comprising:
a reflector to reflect outgoing light toward the inside of the ceramic tube arranged in a ceramic tube end area including the constricted part.

5. The discharge bulb according to claim 4, wherein the reflector is composed of a metal-mixed conductive coating.
